(19) United States
(12) Patent Application Publication
(10) Pub. No.: US 2014/0128899 A1
(43) Pub. Date: May 8, 2014

(54) Motion Style Acupuncture Treatment Method For Relieving Acute Low Back Pain

(71) Applicant: Joon-Shik SHIN, Seoul (KR)

(72) Inventor: Joon-Shik SHIN, Seoul (KR)

(21) Appl. No.: 13/947,034

(22) Filed: Jul. 20, 2013

(30) Foreign Application Priority Data
Nov. 8, 2012 (KR) 10-2012-0126262

(51) Int. Cl. A61H 39/08; A61H 39/04

(52) U.S. Cl. CPC A61H 39/086; A61H 39/04
USPC 606/189

(57) ABSTRACT

Disclosed is a motion style treatment (MST) technique, more particularly, a method for treatment of diseases using MST technique that includes applying acupuncture to meridians (or acupuncture points) at applied sites of the body of a patient, instructing the patient to move and conduct muscle motion of the above sites while applying acupuncture thereon, which in turn maximizes circulation of bio-energy on the applied sites, and activating stimulation of muscles, ligaments and/or nerves by acupuncture needles to maximize effects of acupuncture stimulation, thereby curing a patient suffering from acute low back pain with serious disability.

### RELATED APPLICATIONS

This application claims priority to Korean Patent Application No. 10-2012-0126262, filed on, Nov. 8, 2012, in the Korean Intellectual Property Office, the entire disclosure of which is incorporated herein by reference.

### BACKGROUND OF THE INVENTION

1. Field of the Invention

The present invention relates to a method for treatment of diseases using a motion style treatment (MST) technique and, more particularly, a method for treatment of diseases using a motion style acupuncture treatment (hereinafter, referring to as ‘MST’) technique that includes applying acupuncture to meridians (or acupuncture points) at applied sites of the body of a patient, instructing the patient to move and conduct muscle motion of the above sites while applying acupuncture thereon, which in turn maximizes circulation of bio-energy on the applied sites, and activating stimulation of muscles, ligaments and/or nerves by acupuncture needles to maximize effects of acupuncture stimulation, thereby curing a patient suffering from acute low back pain with serious disability.

2. Description of the Related Art

As well known in the prior art, most people suffer from mild or serious diseases while in life and pay closer attention to treatment and prevention thereof.

Recently, oriental medicine is rapidly and increasingly provided to the general public, based on scientification and experiential effectiveness thereof, and reliability to the oriental medicine is also considerably increased. In order to conduct acupuncture, finger-pressure therapy, etc. among the oriental medicine, it is necessary to correctly find acupuncture points or nerve parts (meridians) affecting a disease or to which treatment is applied. For instance, there are fourteen (14) meridians and 365 acupuncture points in a human body and a diagram of the human body acupuncture points/meridians. Herein, the meridian is a special nerve part around the body which shows responses of the internal organs and bowels (or signs of illness for acupuncture) on a surface of the body, and the acupuncture point (abbreviated to ‘acupoint’) refers to a point for acupuncturing positioned on the nerve part. The acupoint may be a main area through which an energy point is received or passes the surface of the body, and to which acupuncture, moxa cautery (moxibustion), finger-pressure therapy (‘acupressure’), etc. is performed according to the oriental medicine. In this regard, 14 meridians appear the flow of acupoints and may include, in particular, lung meridian, large intestine meridian, spleen meridian, heart meridian, small intestine meridian, bladder meridian, kidney meridian, pericardium meridian, triple energizer meridian, gall bladder meridian, liver meridian, appointed channel, governing channel, or the like. With development and base expansion of the oriental medicine, a variety of treatment routes to remedy or eliminate menstrual pains of women by acupuncture, moxibustion and/or acupressure have been proposed.

Among such disease treatment methods, acupuncture has a theoretical ground on meridian theory. According to this theory, life energy or bio-energy ‘Gi’ flows through a meridian and the meridian includes acupoints with specific functions. Each acupoint may become a part to which acupuncture is applied according to the oriental medicine.

After finding the acupoint, a skin part having the acupoint is stimulated by acupuncturing the acupoint using an acupuncture needle, to pierce a closed bio-energy path and allow smooth circulation of bio-energy, thus facilitating blood circulation. In other words, stimulation of acupoints may induce internal control action of the body and increase a natural recovery (or cure) ability, thus enabling suppression and/or precaution of diseases of the human.

However, in recent years, such a standpoint that acupuncture alone has limited treatment effects of diseases has been brought to the fore.

Acupuncture is widely used for patients suffering from acute low back pain (aLBP) although technical efficacy of the acupuncture for aLBP is not sufficiently proved. MST is a non-traditional acupuncture therapy that makes a patient to move while applying the acupuncture. The present study has been conducted to assess effects of MST with regard to aLBP with serious disability, which did not obviously demonstrate effects of acupuncture. In addition, MST is used to relieve pains in a musculoskeletal system and improve functionality thereof in Korea.

Low back pain, i.e., LBP, occurs significant impacts personally and socially and such a symptom that about 70 to 80% of adults experience at least once in a lifetime [see reference 1]. In 1998, about 26.3 billion dollars were expended due to LBP in United States [see reference 2]. Back pain (BP) is generally self-limited and positive and patients undergoing acute BP may usually become better in one month or can return to work (or in their former positions) [see references 3 and 4].

However, 2 to 7% of the patients show the progress into chronic BP and chronic or regenerative BP may cause 75 to 85% of absence from works [see references 5 and 6]. Accordingly, in case of occurring acute BP, it is important to apply a method of treating while minimizing side effects to thus relieve pains, which in turn improves functionality, reduces a rate of absence and suppress the progress into chronic BP [see references 7 and 8].

Treatment of LBP generally includes prescription of an analgesic agent, for example, acetaminophen, or non-steroid anti-inflammatory drugs (NSAIDs) and also encouraging a patient to continuously retain daily activity [see references 9 and 10]. NSAIDs are effective for curing BP a short period of time and, in an aspect of relieving pains, more superior over acetaminophen [see reference 11]. In most general, intramuscular application of diclofenac is a method of curing acute pains [see reference 12]. However, using NSAID often causes side effects in the stomach (and intestines) [see reference 13]. There is currently an increasing concern about safety of cyclooxygenase-2 selective NSAIDs for cardiovascular diseases, in particular, thrombotic diseases such as acute myocardial infarction, unstable angina pectoris, cardiac arrest, sudden (cardiac) death, etc. [see reference 14].

Although acupuncture has been widely used for treatment of BP, its efficacy is still a controversial topic. As a result of overall consideration of related documents, it was determined that acupuncture shows short-term effects in relieving pains of chronic BP and improving functions of a body. However, for acute BP, no evidence to demonstrate efficacy of the acupuncture has been found [see reference 15]. According to instructions of LBP treatment, acupuncture alone was recommended for curing chronic LBP [see references 9 and 10].

Performance of acupuncture (that is, acupuncture stimulation or applying acupuncture) may include a variety of ways. MST is substantially different from any traditional acupuncture technique and is often conducted in Korea. However, clinical studies on MST efficacy still have to be done. MST is similar to the traditional acupuncture in view of inserting an acupuncture needle into an acupuncture stimulation spot (‘acupoint spot’). However, MST is a novel method that makes a patient to passively or actively move a part of the body while inserting the needle into the acupoint spot for a constant period of time.

MST is clinically used for acute LBP treatment, however, a principal mechanism thereof is substantially not disclosed in the art even though objective assessment of physical dysfunctions and/or any change occurred after applying MST has been done. Accordingly, information on MST efficacy by physicians is usually based on direct and subjective judgment of patients about a change in level of pain.

### SUMMARY OF THE INVENTION

Taking circumstances of the above conventional arts into consideration, the present invention has been done and an object of the present invention is to provide a method for treatment of diseases using MST, which includes applying acupuncture to acupoints at applied sites of the body of a patient, instructing the patient to move and conduct muscle motion of the above sites while applying acupuncture thereon to maximize circulation of bio-energy on the applied sites, and activating stimulation of muscles, ligaments and/or nerves by acupuncture needles to maximize effects of acupuncture stimulation, thereby curing the patient suffering from acute LBP with serious disability.

More particularly, the present invention is designed to test a hypothesis suggesting that MST performed on an aLBP patient with serious disability provides the following results: that is, quantification of pain by comparison between numerical rating scale (NRS) and oswestry disability index (ODI) and a change in disability indicator.

According to one embodiment of the present invention to accomplish the above objects, there is provided a method for treatment of diseases using MST that includes: applying acupuncture to acupoints at applied sites of the body of a patient; instructing the patient to move and conduct muscle motion of the above sites while applying acupuncture thereon, to maximize circulation of bio-energy on the applied sites; and activating stimulation of muscles, ligaments and/or nerves by acupuncture needles, thereby curing a patient suffering from aLBP with serious disability accompanied with or without leg pain.

According to a preferred embodiment of the present invention, there is provided a method for treatment of diseases using MST, including; applying motion to the needles inserted into the acupoints to relax muscles, ligaments and/or nerves near the acupoints, after acupuncture stimulation and before proceeding MST, if the patient has serious sclerosis of muscles, ligaments and/or nerves.

According to another preferred embodiment of the present invention, there is provide a method for treatment of diseases using MST, including; executing chiropractic soft tissue therapy as a pre-treatment process to relax muscles or ligaments of diseased areas before proceeding MST.

As described above, a conventional acupuncture technique comprises applying acupuncture then leaving an acupuncture needle for a long time as it is to cure the body of a patient, however, shows relatively low stimulating effects upon acupoints and muscles, nerves and/or ligaments near the acupoints. On the contrary, the treatment method of diseases using MST according to the present invention has an advantage of accomplishing rapid treatment effects since the patient is instructed to continuously move to thus give continuous motion to muscles near or adjacent to applied acupuncture sites, which in turn equally stimulates muscles, nerves and/or ligaments and activates functions thereof, after acupuncture stimulation.

More particularly, MST performed on an aLBP patient with serious disability may provide the following results: that is, quantification of pain by comparison between NRS and ODI and a change in disability indicator.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating procedures of a method for treatment of an aLBP patient using MST according to one embodiment of the present invention;

FIG. 2 is a flow chart illustrating procedures of assessment of treatment efficacy in subjects participated in a process of remedying aLBP patients using MST according to one embodiment of the present invention, that is, an MST group and an NSAIDs injection group, respectively; and

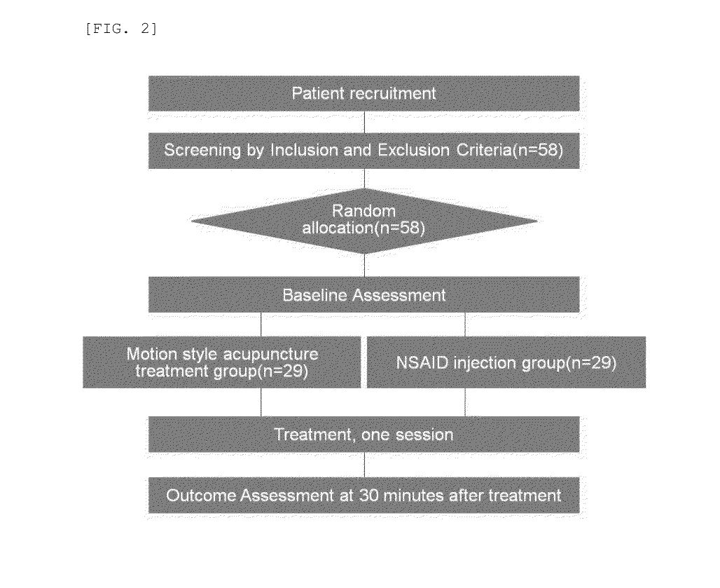

FIG. 3 is graphs showing measured values of practical assessment objects (LBP, nerve root-based pain, ODI, patient's general image change (PGIC), etc.) obtained by comparing results obtained from the MST group, before and 30 minutes after MST according to one experimental example of the present invention, to those of the NSAID injection group.

FIG. 4 shows variation in pressure in disks to postures/100 at pressure during standing up (blue circle).

### DETAILED DESCRIPTION OF EMBODIMENTS

Hereinafter, the present invention will be described in detail with reference to the accompanying drawings.

The method for treatment of diseases using MST according to one embodiment of the present invention comprises a treatment process including: applying acupuncture to acupoints at applied sites; instructing a patient to move and conduct muscle motion of the above sites while applying acupuncture thereon, to maximize circulation of bio-energy on the applied sites; and activating stimulation of muscles, ligaments and/or nerves by acupuncture needles to maximize effects of acupuncture stimulation, thereby curing an aLBP patient with serious disability.

A bone of the human body is generally accompanied with multiple muscles, ligaments and nerves distributed thereon, MST of the present invention may achieve more treatment effects in diseases wherein applied sites for acupuncture stimulation are formed due to disorders of such muscles, ligaments and/or nerves as described above.

MST of the present invention is preferably conducted in parallel with chiropractic soft tissue therapy (‘Chuna treatment’) and Chuna treatment is a traditional therapy having a history of about several thousand years that corrects distorted bones and activates capacity for exercise of skeletal muscles to cure knotted (or stiff) diseased areas. Therefore, Chuna therapy is closely associated with MST and may be a pre-treatment process of MST, wherein acupoint spots are stimulated using needles and self-motion of muscles while applying acupuncture. Briefly, Chuna therapy may refer to a process of treating bones and skeletal muscles.

Of course, a method of applying motion to applied acupuncture sites after applying acupuncture without Chuna therapy, that is, MST may be directly performed. However, when any pre-treatment process is omitted but MST is directly conducted, it is concerned that patients may sometimes feel pain.

Accordingly, Chuna therapy is preferably performed in parallel with MST in order to relax stiff muscles around applied sites beforehand while relieving pain of the patient.

The following description will be given to concretely describe a method for treatment of major diseases deriving pain of the lumbar and aLBP caused by the same.

I. Major Diseases Deriving Pains of Pelvis and Lumbar

Posture Injurious to the Lumbar

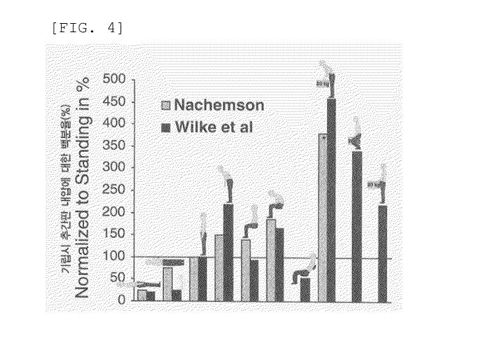

In general, motions hard on the lumbar are represented by FIG. 4.

As shown in table FIG. 4, when a person is carrying heavy packages with his(her) hands while bending at the waist, it can be seen that the pressure increases about 4.5 times at a state of standing up.

Diseases often causing pains in low back (that is, the lumbar) and pelvic of a person are as follows, and methods for examination, diagnosis and/or treatment of these diseases are well known in the art.

1) Herniated Intervertebral Disc (HIVD)—Lumbar Radiculopathy

1. Definition
This disease is often called sciatica and accompanies neurotic disturbance (or disorder) in association with lower limbs to a certain extent.
This disease may occur by stimulating the fifth lumbar nerve and the first sacral nerve due to extrusion of nucleus pulposus and, optionally, caused by direct nerve root compression and/or chemical stimulation of substances in the nucleus pulposus.
Prevalence of HIVD is about 2% of total population and 10 to 25% among them with HIVD show continued symptoms of six (6) weeks or longer. Cases requiring surgery may range from 5 to 10% of total disc patients.

2. Clinical Findings
This disease generally expresses serious (acute) symptoms and is often accompanied with low back pain. Some patients say sometimes that previously suffered pain disappeared after having leg pain.
The pain becomes increased during sitting, coughing or sneezing.
It may be difficult to posture for convenience while reducing pain. When taking a pose bending knees and putting the same to the chest, the disc is expanded and the patient should bend as much as possible to increase an inner radius of a spinal cavity, thus helping easy the pain.
There are typically pains from the hip toward posterior or postero-lateral parts up to the ankle or foot.
For a neuromuscular disease at the center of lumbar (L1-L3), referred pain is expressed at anterior thigh but, usually, not extended below the knee. HIVD on this site is not higher than 5% of overall HIVD.

3. Examination

(1) Physical Examination
Observing whether the trunk (whole body) leans to one side when a patient stands up
Investigating as to whether a patient feels pain while stretching the waist when he (she) sits down and raises the leg. This test studies high possibility of HIVD and, in particular, the possibility of HIVD may increase if pain further arises at an angle of less than 45° in SLR test.
Investigating as to whether a patient feels pain during extension of the hip joint at a prone position. For a test case determined to be positive, it implies L3 root lesion and cases exhibiting L2 or L4 root disorders are sometimes determined to be positive.

<Typical Findings Along with Levels of Disc>

(i) L3/4 Disc (L4 Root):

Muscle weakening of ankle dorsiflexor, numbness around shin part, thigh pain and asymmetric hamstring reflex are found. About 5% of intervertebral disc rupture arises at the present site.

(ii) L4/5 Disc (L5 Root):

Weakened extensor hallucis longus muscle, insensibility on dorsum of foot and between big and second toes, and pains around postero-lateral thigh and calf are found.

(iii) L5/S1 Disc (S1 Root):

Weakened gastrocnemius muscle and troubles in walking with toes. Insensibility at the outer side of foot, calf pain and asymmetric ankle reflexes are found.

(2) Clinical Test
L-spine ROM
SLR (Straight leg raising test): Root compression sign of L5 or S1 nerve
Valsalva sign: Space-occupying lesions in cervical, thoracic and lumbar spines (disc; tumor; tuberculosis; abscess, etc.)
DTR (Deep tendon reflex): If it is degenerated, root compression. For a case of acceleration, diseases of upper motor neurons (from cerebrum to spine)
Ankle clonus: Diseases of upper motor neurons (from cerebrum to spine).
G-toe powder: Investigation of disorder of lower motor neurons

(3) Imaging Diagnosis
Plain X-ray
CT
MRI
EMG (Electromyography)

2) Spinal Stenosis

1. Definition
This refers to a disease wherein, owing to certain reasons, a spinal canal, nerve root canal or intervertebral cavity is narrowed to induce low back pain or cause a variety of complicated neuroses on legs.
In general, the nucleus pulposus and fibrous ring begin to be degenerated after 30 years old, and thus, a part of intervertebral disc adhered to the spin is detached to remain bone spur. Simultaneously, posterior joint protrusion, vertebral arch, ligament flavum, etc. may also be deformed and thickened to make all area around the spinal canal to be narrowed. Further, the spin is bent in front and rear directions to directly press the spinal cord and nerve roots and cause blood flow disorder, resulting in occurrence of symptoms.

2. Clinical Findings
Low back pain is very often expressed, dislike lumbar intervertebral herniation, sensory disorder and weakened muscular strength as well as sharp, squeezing or burning pain arises around the hip and anus accompanied with sensory disorder and weakened muscular strength. Such symptoms as described above are generally worse under cold weather or during exercising but improved under warm weather or when a patient is at ease.
For symptoms often arising and becoming serious, these symptoms disappear when the patient bends at the waist or stops walking but crouches down to rest, while being repeated by walking again. Such a condition as described above typically refers to as neurogenic intermittent claudication. As an extent of stenosis is increased, a walking distance may be shortened.
Conditions of a sensory disorder, such as sensibility loss or numbness, may be expressed over a wide area of the body along with calf, ankle, knee, thigh, hip and inguinal regions. Anus dysfunction is the latest symptom.

3. Examination
Through simple radiation examination and spinal MRI, extents of intervertebral disc deformation and spinal compression are assessed. In particular, spinal CT should be used to determine as to whether external recess positioned beside the spinal canal is under stenosis. Myelography may show that the spinal dural sac is entirely or partially narrowed, narrowed at both sides thereof to exhibit a hour glass morphology, or provide such a finding that a contrast medium for myelography is completely blocked in the spinal dural sac. Alternatively, MRI may more concretely show a compressed part in the spinal dural sac. For cervical vertebra stenosis, if a gap or interval between front and back portions is found to be 12 mm or less in the simple spinal radiation examination, there is a doubt about the above disease. Further, CT myelography may also be helpful.

3) Degenerative Disc

1. Definition
This refers to a disc condition with degraded mechanical and/or chemical properties of the intervertebral disc due to various causes including, i.e., ageing, trauma, high impacting activity, type of works, smoking, genetic factors, and so forth.

2. Clinical Findings
A mechanical disorder having low back pain during bending or stretching the body and neurotic disorders having leg pain during sitting down or walking are expressed.
A degenerative intervertebral disc disease often arises without specific symptoms.
Patients with typical degenerative disc explain that a pain arises when getting up in the morning, however, disappears during walking about 1 hour.

3. Examination
Extent of sliding of the spinal bone is determined through X-ray and whether fracture of joint protrusions arises or not is diagnosed. Further, extent of nerve compression may be accurately diagnosed by MRI if there are some neurotic symptoms such as numbness of legs.

4) Spobdylolisthesis

1. Definition
Vertebra comprises multiple small bonds stacked in a tower form. Joint protrusions in a ring type ring placed at a rear part of the vertebra fix upper and lower bones. Spobdylolisthesis refers to a disease wherein the upper spinal bone slides and is forced out toward the front due to various causes such as damage of joint protrusions.
Major causes may include degeneration of discs and joints, congenital spinal abnormality, accident, impact-derived fracture of spinal joint protrusion, and the like.

2. Clinical Findings
In a case of standing up after sitting down or stretching (or bending) backward at the waist, low back pain is caused.
When getting up in the morning, low back pain is caused.
In a case of taking a stand for a long time or walking a long distance, it causes pains in the waist, hip and/or below knees.
By passing a hand over the spine during straightening the waist body and touching the body, depressed parts are found.
Walking with faltering steps like a duck is found.

3. Examination
Extent of sliding of the spinal bone is determined through X-ray and whether fracture of joint protrusions arises or not is diagnosed. Further, extent of nerve compression may be accurately diagnosed by MRI if there are some neurotic symptoms such as numbness of legs.

5) Facet Joint Syndrome

1. Definition
Pain-derived conditions through nerves distributed over a facet joint since a joint membrane of the facet joint sensitive to pains has acute trauma or degenerative modification, thus causing fracture of the face joint membrane or arthritis.

2. Symptoms
Pain of which the position is not certainly detected or traced
Symptom of strain from the hip to the posterior thigh (similar to intervertebral disc disorder)
Radiating pain of the lower limbs is not usually broadened below the knees
Pain increasing when getting up in the morning, however, decreasing during activity
Pain decreasing during bending frontward, however, increasing during stretching and bending in lateral sides

3. Treatment in Western Medical Procedures

Drug administration, physical therapy, facet joint injection, etc.

1) Deep Tendon Reflex
A principal examination method is conducted for right and left parts of the body of a patient in a relaxed state and, for comparison, other parts of the body should also be under test to determine differences therebetween. Deep tendon reflex may be classified into four (4) grades from grades 0 to 4, expressing loss, low, normal, higher and very higher, respectively, in terms of contractibility, speed, range of motion of muscle.

(1) Biceps reflex (C5.6): After bending a main joint of a subject to be tested almost at a right angle and placing a thumb of an inspector on a tendon of the biceps of the subject, tapping the thumb using a hammer results in contraction of the biceps to make the forearm to be bent and rotate externally.

(2) Triceps reflex (C7.8): Tapping an upper part of the origin of triceps of the olecranon results in contraction of the triceps and extension of the forearm.

(3) Patellar reflex or knee jerk (L3.4): After seating a subject to be tested in a test table and making him (her) to hang both legs down the table or to lie thereon, the inspector holds the knee by hands and taps the knee jerk just below the knee bone. As a result, extension of the knee due to contraction of the quadriceps is observed.

(4) Achilles tendon reflex or ankle jerk (S1): After making a subject to be tested to lie in comfort, bending the knee and rotating the same externally, the inspector applies dorsiflexion to a foot of the subject. Otherwise, after making the subject to lie on his(her) face, bending the knee and applying slight dorsiflextion to the foot of the subject, the inspector taps the ankle jerk. As a result, extension of the ankle joint is observed.

2) Superficial Reflex
An examination of exercise response after stimulating skin or mucosa of a subject to be tested.

(1) Cremasteric reflex (L1.2): When scratching an inner top part of the thigh downward, the corresponding testis rises upward. This activity may be lost if lesion is present in the cortical spinal cord.

(2) Anal reflex (S2.3.4): By inserting a finger into the anus and scratching or stimulating the perineal region or around the anus, the external anal sphincter contracts in a normal condition. However, if there is a lesion in a sacral cord or cauda equine part, the above response is lost and the anus may be still open without contraction even after taking the finger out of the anus.

(3) Bulbocavernous reflex (S3.4): When pinching or softly tapping the phallus foreskin or glans, it is determined as a normal condition if a norbulbocavernous contraction is observed or touched.

3) Neurological Examination

(1) Spinal Cord Disease

(a) Hoffman's sign: After relaxing the arms and hands of a patient, and scratching second and third finger tips of the patient by a thumb nail and flipping the same to apply pain thereto, the present disease is determined to be positive if a thumb or other fingers is(are) bound and a pathway of sixth branch in the cervical spine is present, and it is a pathogenic response wherein abnormal condition of the pyramidal tract is expected. However, in a case where muscular tension is significant, excessive sensitization response may occur and be positive in a healthy person.

(b) Ankle clonus reflex: When rapidly bending the ankle joint of a patient, the present disease is determined to be positive if clonic contraction and relaxation of lower thigh muscle are repeated four or five times. However, this may be normal for infants.

(c) Lhermitte's sign: When a patient maximally bends his head while being seated, the present disease is determined to be positive if there is a sign such as current flowing through the line of a backbone or limbs. Further, it may be suspected of abnormal conditions of cervical spinal cord and multiple sclerosis, spinal tumor, cervical osteoarthritis, ossification of posterior longitudinal ligament (OPLL), radiation-induced myelitis, and so forth.

(d) Babinski's sign: When stimulating the external part of foot sole in a longitudinal direction, the present disease is determined to be positive if the big toe stretches and all toes are widen apart. In particular, widening all toes apart refers to as ‘Fan sign’, which may be a normal response for six to twelve month-old infants. Further, this is a disorder reaction wherein abnormal conditions of the pyramidal tract may be expected.

(2) Root Disease

(a) Cervical Root

(i) Spurling's sign: When stretching the head in a direction of the upper limb pain, bending the head at a lateral side and pressing the same downward, the present disease is determined to be positive if a neuropore is further narrowed to compress the nerve root and induce radiating pain. Herniated cervical intervertebral disc and neuropore stenosis may be suspected. Such radiating pain may disappear by tilting the head in the opposed direction of the lesion.

(ii) Shoulder abduction test: When evaginating an arm having lesion and raising the hand of the arm, the present disease is determined to be positive if radiating pain or numbness disappears or is reduced. The above pain means a secondary radiating pain caused by a lesion of cervical intervertebral disc.

(iii) Neck distraction test: For a patient usually having the upper limb radiating pain or numbness thereof, when an inspector gently pushes and raises the head of the patient while supporting the chin and occipital region, the present disease is determined to be positive if the radiating pain disappears or is relieved. This means that compression of the nerve root is relived.

(b) Lumbar Root

(i) Straight leg raising test (SLRT): After a patient lies on a bed at ease with the head on a pillow and straighten the knees, the inspector slowly raises the heels of the legs without and with symptoms in this order, respectively. The present disease is determined to be positive if low back pain or lower limb pain is expressed. This means that the nerve root is compressed according to distribution of the same through which the pain passes. Mostly, compression lesion of 4^{th}/5^{th} sacral spinal nerves in the lower lumbar spine may be suspected.

(ii) Crossed straight leg raising test: In a case where the nucleus pulposus is significantly herniated toward the center of a neural tube, the inspector conducts SLRT of a normal leg. The present disease is determined to be positive if the radiating pain of a paralyzed leg is worse or induced. The reason of this face is because the nerve in the leg having lesion is compressed by the herniated nucleus pulposus due to traction of the nerve root in the normal leg. This may also refer to as ‘Peyton sign.’

(iii) Femoral nerve stretch test: After a patient lies on the face at ease, the inspector presses the hip by one hand while supporting the knee and raising by the other hand or, otherwise, pressing the back of the knee by one hand while raising the foot by the other hand to bend the knee. The present disease is determined to be positive if pain is induced around the overall thigh or shin part or pain in usually uncomfortable part is worse. Mostly, compression lesion of the upper lumbar roots, that is, 2^{nd}/3^{rd}/4^{th} nerve roots may be suspected.

(iv) Bowstring sign: At a position that positive pain is expressed during SLRT, the inspector bends the knee joint and presses a popliteal nerve part in the popliteal of the knee joint using a thumb finger. The present disease is determined to be positive if pain is induced on the thigh or lumbar spine part. Since ‘all or none principle’ of the pain is low in a state of compressing the nerve root by herniation of the intervertebral disc, stimulation of the distal popliteal nerve may induce pain.

(v) Flip test: When a patient fully stretches the knee joint of the lower limb having pain while sitting on a chair, the present disease is determined to be positive if radiating pain of the lower limbs occurs and, at the same time, the upper body is flipped back. The present test is a virtual test and, if there is no radiating pain detected during flip test although the strong radiating pain is expressed by SLRT, it may be determined that the patient does not have a real tendency of tension of the nerve root.

II. Target and Method for Treatment Using SJS H-MST Therapy

1) Motion Style Treatment (MST)
This is a treatment method that allows a patient to move a stimulated part after acupuncture stimulation, thereby accomplishing effective treatment of the patient suffering from a musculoskeletal disease.
An acupuncture stimulating process used herein may comprise a treatment method obtained by combining neuro-physiological theory with traditional acupuncture theory, which may be often compatible with Chuna therapy, however, is different from synchronization in motion style acupuncture treatment generally known in the art.
MST method may be applied to a wide range of diseases including various musculoskeletal diseases as well as low back pain and, in addition to, paralysis-related symptoms, thereby accomplishing clinically effective results.

<Clinical Application>
Clinical application is a general term always referred to by medical specialists and pharmacists, however, may be unfamiliar to ordinary persons without clinical test experience. A dictionary definition of clinical application is “diseases or conditions that may be expected to be efficiently treated by a certain medication, surgical operation, etc.” Alternatively, according to examination institutions in Korea, the clinical application may be defined as “medical efficacy/effect,” and this definition means that “particular names of diseases or conditions showing tried-and-true.” In the present invention, the following patients may be subjected to the clinical application described above.

(a) Patient suffering from very severe pains on the waist and lower limbs due to acute sprain of lumbar spine or HIVD, who has problems with normal activities.

(b) Patient suffering from significant pain in such an extent that ROM of the lumbar spine is extremely limited. Further, when the patient moves or changes a posture, pain is significantly increased and makes it so difficult for the patient to move by himself(herself).

(c) With radiating pain of the lower limbs, a variety of clinical aspects from simple dysesthesia to serious pain at the lower limbs may be appeared.
Applying the present clinical application to a patient with tried-and-true
As a patient has strong pulse and more severe pain, H-MST is more effectively applied.
For a weak patient with lower energy, weak voice and/or difficulties in keeping himself(herself) steady, several days after recreating self-healing power of the patient, H-MST is conducted.

(Ex) Summary of treatment of weak patients with disorder of the digestive system

Step 1: A herbal medicine, Gwakhyangjeonggisan (1 day, when some symptoms such as diarrhea and abdominal pain)

Step 2: A ginseng extract-containing medicine, Insamyangwi-tang+an oriental medicine, Anjungsan (1 day)

Step 3: A ginseng extract-containing medicine, INsamyangwi-tang+a herbal medicine, Chungwoongbaro

Step 4: A herbal medicine, Chungpajun+a herbal medicine, Chungwoongbaro
After improving self-healing power of the patient, the patient is duly subjected to treatment of herniated disc.

2) Summary of Treatment (Applicable Depending Upon Condition of Patient)

(1) Full knowledge of patient and relaxation

(a) After simple medical inquiry, SLR test is executed in a supine position. After checking muscular power of the ankle and big toe, Cauda Equina syndrome (CES) is excluded by determining as to whether a patient has elimination disorder.

(b) In a supine position, iliopsoas induration is checked and, if it is found, iliopsoas MST is conducted to eliminate the induration. If the spine is bent or the patient appeals pressure pain around quadratus lumborum muscle, MST of the quadratus lumborum muscle conducted. Likewise, if the patient appeals radiating pain and abnormal sensitivity on the lower limbs and hip, pirifomis muscle MST is conducted.

(2) Chuna Therapy

(a) Chuna therapy is executed after leg check and sacrum shifting analysis.
Simple posterior inferior illum manipulation
Complex posterior inferior illum manipulation
Prone position posterior inferior sacrum adjustment

(b) Extension of lateral position lumbar spine is performed.

(c) JS-121 technique is executed.

(3) Acupuncture stimulation and H-MST application

3) Theoretical Ground of Treatment Effect

1. The acute low back pain may be expressed by nerve compression due to; damage to muscles and ligaments around the spine, sprain of posterior joint, partial tearing of the fibrous ring in the intervertebral disc, herniation of nucleus pulposus, or the like. Owing to the damage of soft tissues, a pain signal may enter a spinal olfactory part in a corresponding segment to stimulate the central nervous system, and induce convulsion and contraction of muscles controlled by the segment described above. Accordingly, with regard to clinical signs, all activities of the spine are limited due to muscular convulsion as well as pain, and muscle stiffness is expressed (Macnab's backache, Chun-sung LEE, 4^{th} Ed., Seoul: Gabon medicine. 2008:179-80).

Such a sudden limitation to exercise as described above may cause patients to have some emotions such as anxiety, depression, etc., and open a pathway through which the pain signal passes, thus being more sensitive to pains and worse symptoms (Macnab's backache, Chun-sung LEE, 4^{th} Ed., Seoul: Gabon medicine. 2008:66)

2. A general treatment method of the acute low back pain currently known in the art is bed rest. However, continuous bed rest in a state of muscle stiffness may leave a locking condition of the waist by convulsion of the muscle around the spine as it is, hence showing a tendency of continuing the low back pain (Macnab's backache, Chun-sung LEE, 4^{th} Ed., Seoul: Gabon medicine. 2008:180).

3. A principle of H-MST is firstly overall relaxation of the muscle around the spine. Drawing a patient and continuously relaxing the muscle around the spine contracted at either side or both sides, thus improving symptoms.

4. When assistants positioned at both sides of a patient relax the muscle around the spine of the patient, mechanical action may be applied to separate a disc between vertebras to eliminate a pain arising in a spinal longitudinal part and elongate the muscle through reflection. If such elongation does not cause pain, the same may stimulate a mechanical receptor in the segment and reflectively loosen a protective muscular guarding. H-MST may have analgesic effect through acupuncture stimulation (Diagnosis and treatment of spinal pains, Hoon CHOI, 2^{nd} Ed., Seoul: Gunja Publishing Com., 2008:225).

5. Further, the patient becomes more sensitive to pain and symptoms may be worse, due to psychological effects. Encouragement of the surroundings and relieved feelings, when the patient practically poses to walk, may close a pathway for passing a pain to thus decrease the pain (Macnab's backache, Chun-sung LEE, 4^{th} Ed., Seoul: Gabon medicine. 2008:64).

6. In the case of arising the acute low back pain, a nerve conduction reaction velocity of the muscle around the spine is varied and a posture keeping system becomes unstable, to thus have difficulties in walking. In this regard, the assistants positioned at both sides of the patient may replace a role of the muscle around the spine of the patient and help the patient walking. Further, the unstable posture keeping system may be gradually stabilized, thereby enabling the patient to walk by himself(herself).

7. According to Seze, the acute low back pain caused by (herniated) intervertebral disc arises by blocking of the posterior disc. Pieces of a medullary nucleus may enter a gap between annulus fibrousus and expand external fibers only controlled by nerves. Such an expansion of these external fibers is presumed as a major cause of the pain, although the pain may also be expressed by suddenly applied pressure of a disc protruding out of the posterior longitudinal ligament (‘post-ligament’) (Diagnosis and treatment of spinal pain, Hoon CHOI, 2^{nd} Ed., Seoul: Gunja Publishing Com., 2008:337-8).

For the pain caused by acute intervertebral disc herniation, H-MST may conduct spine traction to strain the post-ligament and push the annulus fibrosus frontward. Further, since an internal pressure of the intervertebral disc is reduced to generate a sucking force, thus absorbing the protruded nucleus pulposus (Cyriax JH: Discussion on the treatment of backache by traction. Proc R Soo Med 45:808-811, 1955).

When a disc space is widened and the post-ligament is elongated to have resilience, the space is maintained after treatment, so as to maximize effects of the treatment. More particularly, blood circulation is improved and an inflammation intermediate such as prostaglandin is rapidly absorbed, thus eliminating congestion and remarkably increasing treatment effect (Diagnosis and treatment of spinal pains, Hoon CHOI, 2^{nd} Ed., Seoul: Gunja Publishing Com., 2008:225).

<Notes>

(a) When a patient with acute low back pain visits a clinic, it is important to primarily guide relaxation of a muscle group supporting the spine.

(b) Since muscles such as iliopsoas muscle, quadratus lumborum muscle, piriformis muscle, etc. are still strongly strained, theses may be a major cause to increase and continue the low back pain.

(c) For a patient with acute low back pain, it is important that Chuna therapy is conducted to relieve tension throughout the spine rather than manipulation of a specific part of the spine. That is, the purpose of Chuna therapy is not to adjust the specific part of the spine but eliminate much stress built up over the spine.

(d) For a patient with severe low back pain, since he (she) often appeals strong pain not only during action but also while taking a rest, Chuna therapy may entail a problem of increasing tension of corresponding muscles if it is conducted too hard.

4) Help (H)-MST Method

(1) SLR Test: Check a condition of the patient through dorsiflexion, plantarflexion, big toe extension and/or medical inquiry.

(2) During SLR test, observe induration of the iliopsoas muscle at the side showing less straight leg raising, then, conduct MST of the iliopsoas muscle to eliminate the induration <see Iliopsoas muscle MST>.
After iliopsoas muscle MST, SLR test is again conducted to determine a degree of improvement.

(3) Chuna therapy such as pelvic adjustment, lateral position lumbar extension, JS-123, etc. is executed (this should be conducted to such an extent that the pain is not increased).

(4) Quadratus lumborum muscle MST and piriformis muscle MST are conducted after Chuna therapy <see Quadratus lumborum muscle MST, Piriformis muscle MST>.

(5) After Chuna therapy and acupuncture treatment, instruct the patient to turn onto a lateral position then raising him (her).
Firstly, let the legs of the patient down and two medical specialists help the patient at both sides to assist him (her) to stand up like he (she) rolls the body.

(6) While closely contacting the arms and waist part at both sides of the patient and tugging at the same, the patient is raised up.
Traction is applied in such an extent that he (she) stands up while touching the ground at the heel (being careful not to leave the heel from the ground).
During tugging the patient, the medical specialist should suitably adjust his(her) height to that of the patient.

(a) In order to maintain the upper limbs of the patient in a straight line, control the traction and be careful not to induce pains at major joints and axillary parts of the patient.

(b) A person to tug the patient (‘attractor’) should contact the body of the patient at his(her) flank as closely as possible and treat the patient, so as to ensure traction of the lumbar part of the patient.
Even if the patient is short, traction is preferably conducted by putting the arm of the patient around the attractor. When an area of the arm of the patient supported by the medical specialist is increased, the patient feels more stable and a load applied to the arm may also be reduced.
In a case where the patient is short and is tugged at the axillary part only, pain may arise at the shoulder of the patient and, since the medical specialist cannot closely contact the body of the patient, traction may not be suitably performed.
If the medical specialist is much taller than the patient, a height should be adjusted to make the patient more comfortable by tugging at the forearm part instead of the brachial part of the patient (when the medical specialist is taller than the patient, the patient feels pain and uncomfortable).

(7) Acupuncture stimulation (0.25*40/total five (5) acupuncture points): two henggans, two gokjis and one pungbu acupoints
Since vertical acupuncture at the henggan acupoint may occur pain, inclined acupuncture at an angle of about 30° is preferably conducted.
If the patient is startled during acupuncture, there is a high possibility to cause internal hemorrhage at the acupoint spot when the needle is pulled out. Therefore, the internal hemorrhage should be prevented by pressing hard the acupoint with dried cotton while pulling out the needle from the body.
When acupuncturing at the gokji acupoint, this acupuncture should be conducted while slightly bending the elbow.

(8) After the acupuncture, instruct the patient to walk in place with the attractor.
During walking in place, check pain at the acupuncture site to set the patient at ease.

(9) If no abnormal condition is found in walking-in-place, let the patient to slowly start walking forward.
During walking, the attractor keeps balance with the patient and controls a walking velocity not to walk quickly and burden the patient. At the beginning of H-MST, the attractor gives a verbal order gently and keeps balance with the patient.
Slightly and gently stimulate the pungbu acupoint while following the walking patient, and control the patient.

(10) In the middle of H-MST, teach the patient to improve treatment effect.

(11) Continuously check the condition of the patient, and decrease a level of traction (from level 3 to level 0/from the paralyzed side to the normal side).
With regard to a decrease in the level of traction, this should be done while checking the condition of the patient at constant intervals.
Level 3 (100% traction): Prevent a gap from being present between the patient and the medical specialist.
Level 2 (50% traction): Reduce traction by 50% and slightly loosen the body of the patient.
Level 1 (20% or less traction): With minimal traction, do not apply force to the patient.
Level 0: The patient can walk by himself(herself) with the arms swinging back and forth.

(a) First, decrease the traction for the paralyzed side from level 3 to level 2, then, level 2 to level 1.

(b) If the patient can walk after decreasing the level of traction for the paralyzed side, decrease the traction for the normal side from level 3 to level 2.

(c) Thereafter, decrease the traction for the paralyzed side from level 1 to level 0 and instruct the patient to walk while swinging the arm at the paralyzed side back and forth.

d) For the normal size, slowly decrease the traction from level 2 to level 1, then, level 0, and allows the patient to walk by himself(herself).
In order to give the patient confidence, actively shout an order during H-MST.

(12) After the patient walks a distance of about 20 to 30 m, pull out the acupuncture needle from the body.
When the patient walks by himself(herself), continuously instruct the patient to have confidence.

(13) After pulling out the acupuncture needle, let the patient to rotate the waist in right and left sides for stretching, and to recognize that no pain is induced by such a motion as described above.

(14) After desired treatment effects are accomplished, give some instructions for attention.
After H-MST, the patient should lie on a bed for about 30 minutes to be stable.
Be careful not to take a seat just after the treatment.
When the patient was sapping strength too much or strained during treatment, a proper medicament such as Woohwangchungsim-won widely used for acute diseases may be dosed once.

As such, the above description is provided for concretely explaining Help-MST with help of assistants among MST methods. However, the present invention is not particularly restricted to the above and other MST methods (i.e., Walker-MST; Self-Walking-MST, Sandbag-MST, etc.), which are used for patients capable of behaving by themselves, may also be included within the scope of the present invention. These MST methods may also be applied to patients having improved symptoms after Help-MST. Such MST methods as described above may be briefly introduced as follows:

5) MST in Steps

Step 1: Help-MST (H-MST)
In a case where a patient cannot move by himself(herself) due to acute low back sprain and herniated intervertebral disc, the present treatment is conducted as a first aid.
Since the patient cannot move by himself(herself), two medical specialists tugs at both shoulders of the patient and eliminate tension of the lumbar part, thereby enabling the patient to walk by himself(herself).

Step 2: Walker-MST (W-MST) <See the Description of H-MST>
In a case where a patient can move by himself(herself) but the waist is twisted or the hip is back out, the present treatment is conducted when the patient has difficulties in walking without a walker device.
Instead of tugging by two medical specialists, use the walker device to smoothly conduct traction.

Step 3: Self-Walking-MST (SW-MST)
In a case where a patient can walk using a walker device for about 20 minutes without pain and walk by himself(herself), however, feels a little (or something) uncomfortable, the present treatment is conducted.

Step 4: Sandbag-MST (SSW-MST)
In a case where, although a patient can conduct self-walking and daily life without pain, there is low back pain accompanied with degenerative intervertebral disc, the present treatment is conducted to target reinforcement of ligaments around the spine.

6) Description of Acupuncture Points (Meridian Point-Related Significance of Henggan, Gokji and Punbu Acupoints)
With regard to MST therapy as described above, important acupuncture points, that is, acupoints, applicable in acupuncture stimulation may be described as follows:

(1) Henggan (LR2)
Henggan is a liver acupoint functioning as the liver meridian. Branches of the pulse of liver are stiffed together with the pulse of the energizer meridian between the bladder channel B33 and the bladder channel B34 below the waist and pelvic, to block and close bio-energy of the meridian, thus causing low back pain. In this regard, the henggan acupoint serves as a meridian for treatment and can treat the above low back pain.

(2) Gokji (LI11)
The present acupoint is a spot effective to remove pathogenic heat, help joints and control blood and bio-energy circulation. Bio-energy is life energy to effect physiological activity and external activity of the human, comprising; five function such as activation of bio-energy, warming, defense reaction, variation of bio-energy, and control of bio-energy (to prevent the bio-energy from flowing toward undesired routes). Therefore, by taking the gokji acupoint to combine ‘Yeong’-‘Wigi’ energies and select an acupoint near eye (GV4), the origin of bio-energy is activated and bio-energies are harmonized by internal combination of energy, thereby accomplishing desired treatment effects.

(3) Pungbu (GV16): Governing Channel
The present acupoint effects to remove the symptom ‘Pungsa,’ refresh the mind and eliminate heat inside the body. This is used for treating neck and nuchal pain, numbness of limbs, cold, headache, stroke, psychological disease, and so forth.

7) Definition of Terminologies for Body Parts to be Treated

(1) Iliopsoas muscle: Iliopsoas muscle is a muscle connecting the spine and lower limbs. If sitting for a long time, the present muscle remains to be shortened. With ageing, extendibility (or flexibility) of a muscle is naturally reduced, thus being shortened and tighten. As the iliopsoas muscle is shortened, a person sways back and stoops down.

(2) Quadratus lumborum muscle: Quadratus lumborum muscle is a muscle positioned at lateral sides of the spine and becomes a cause of chronic low back pain. In particular, radiating pain itself is mostly expressed on the pelvic and lower limbs. When a disease occurs, the present muscle may cause a virtual intervertebral disc syndrome together with gluteus minimus muscle or pains not treated by surgical operation. Therefore, the above conditions may be effectively treated in association with external muscles, rather than control of signs of the quadratus lumborum muscle alone.

(3) Piriformis muscle: Piriformis muscle is a muscle positioned in the deep parts of gluteus medium muscle and gluteus minimus muscle and includes a sciatic nerve descending to the lower limbs interposed between external rotator muscles (including upper and lower gemellus muscles, inner and outer obturator muscles, thigh quadrate muscle). This is preferably managed together with gluteus maximus muscle to have desired effects, in terms of functionality.

An external binding position of the piriformis muscle may be adhered to an inner side of the top of a greater trochanter just below a binding position of the gluteus minimus muscle, while an internal binding position thereof is adhered to an inner side of the sacrum, therefore, the piriformis muscle directly effects movement and variation of the sacrum.

As such, a treatment method of the lumbar spine using MST according to the present invention has been described above. If the pain and symptoms of the lumbar spine are serious, the above treatment method preferably includes; inserting an acupuncture needle into an acupoint spot of a patient then applying motion to the needle in order to relax muscles, ligaments and/or nerves around acupoints in the acupuncture site, before acupuncture stimulation and MST, followed by making the patient to conduct MST by himself(herself). For instance, for a patient with acute low back pain, Chuna therapy may be firstly executed to relieve tension throughout the spine. The purpose of the above treatment is to eliminate stress built up throughout the spine, rather than manipulation of a specific part of the spine.

A method for treatment of a disease using MST according to preferred embodiments of the present invention is not particularly restricted to the following examples, however, various modifications and alterations thereof may be possible without departing from technical concepts of the present invention.

### Example

### Project

In a prospective and randomized study, 58 participates have been recruited. These participates were divided into: (a) a group with MST (n=29); and (b) a control group with NSAID treatment (n=29).

Applicants, that is, the participates have been selected among acute low back patients having 60% LBP oswestry disability index (ODI), and all procedures of treating both groups were carried out only one time (that is, in a single period of time). Determination of clinical results were obtained before and 30 minutes after the treatment, respectively.

In consideration of patient's general image change (PGIC), ROM of the lumbar spine, SLR extent, etc., results of NRS values and ODI values collected from both of the applicant groups described above are assessed.

Discussion

The results of the present clinical study are reviewed and discussed.

[Method]

Summary

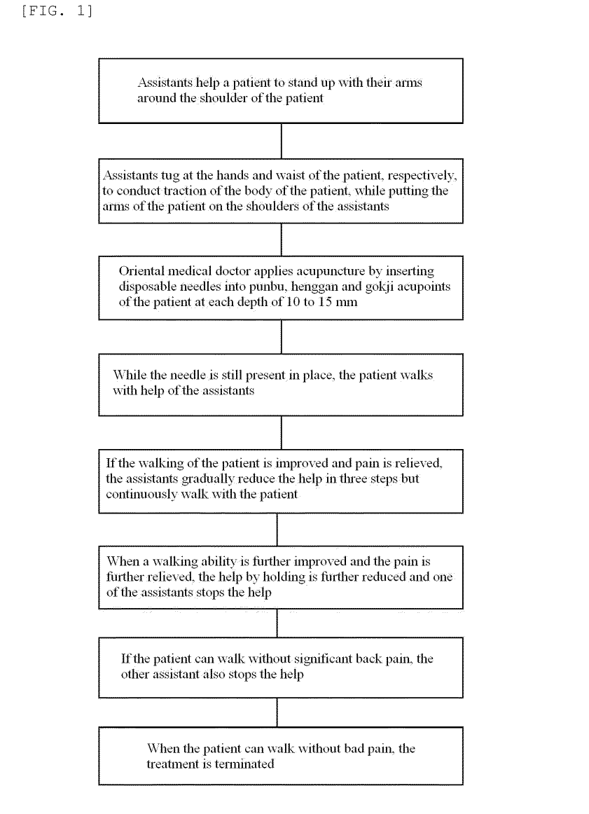

After being granted permission of Clinical Research Committee for two institutes (Jaseng Hospital of Oriental Medicine in Seoul and Jaseng Hospital of Oriental Medicine in Bucheon), the present study was performed in both of the above hospitals. Among outpatients of these hospitals, 58 applicants were registered as participates of the present study. 29 of these participates were selected as subjects to have H-MST while the other 29 persons became a control group to have NSAID treatment. Two groups were subjected to H-MST and NSAID injection, respectively (see FIG. 1).

Recruit of Candidate

A treatment group is recruited from outpatients with acute low back pain who visited Jaseng Hospital of Oriental Medicine (Seoul) and Jaseng Hospital of Oriental Medicine (Bucheon). When these patients interest in participation to the present study, a researcher of the present study directly meets them and determines eligibility for preliminary screening. If an applicant satisfies standards for clinical study, he (she) may be subjected to examination of eligibility by a medical specialist. Next, the researcher receives the letter of agreement from each eligible participate and circulates a basic questionnaire to the same.

Eligibility or Qualification (as a Test Group)

Standards for Adaption
Patient having significant disability defined by ODI=60%
Patient aged 20 to 60 years old
Patient who accepted MRI of lumbar spine and agreed with procedures thereof
Patient who voluntarily agreed with participation to the present study and signed the prepared letter of agreement

Standards for Exclusion
Patient diagnosed to have significant diseases possibly inducing low back pain (ex., tumor, fracture of spine, spinal infection, inflammatory spondylitis, cauda equina syndrome, or other ineligible conditions)
Patient having chronic diseases affecting treatment effects or analysis of treatment results (ex., cardiovascular diseases, diabetic neuropathy, fibromyalgia, rheumatoid arthritis, dementia, epilepsy, or other ineligible conditions)
Patient with progressive neurologic deficits or serious neurologic syndromes
Patient who is not suitable or unsafe for acupuncture treatment (ex., hemorrhagic disease, coagulopathy, application of anti-coagulation therapy, severe diabetes with risk of infection, severe cardiovascular disease, or other ineligible conditions)
Patient who takes adrenal cortical hormone, immune-suppressant, psychological medicine, or other drugs possibly affecting results of the clinical study
Patient who is pregnant or planning to become pregnant
Patient who is determined to be ineligible for clinical study by the researcher

Treatment Protocols

After collecting NRS and ODI results, a single MST is provided to 58 subjects for about 20 minutes. Second sheets for recording results of the treatment are collected from all of the subjects.

MST Method

An acupuncture treatment is performed by an oriental medical doctor having medical experience of at least 3 years. Doctors must complete a period of workshop three times before participating in the present clinical study, in order to perform the acupuncture treatment according to corresponding practical treatment protocols.

First, after taking off shoes and socks and putting galoshes on a patient, assistants stand up at both sides of a subject, that is, the patient. They help the subject to stand up with their arms around the shoulder of the subject. Then, the assistants tug at the hands and waist of the subject, respectively, like as they raise their hands, to conduct traction of the body of the subject, while putting the arms of the subject on the shoulders of the assistants. Herein, the assistants closely contact the patient as much as possible at their flanks to sufficiently conduct traction of the body of the patient. At this position, the oriental medical doctor applies acupuncture by inserting disposable needles into punbu acupoint GV16, both henggan acupoints LR2 and both gokji acupoints LI11 at each depth of 10 to 15 mm. Such acupoints were selected according to traditional theory of oriental medicine and the past clinical medical experiences. When applying acupuncture to both lateral sides of GV16 and LI11, the needles are aligned on spots perpendicular to the surface of the human body. For LR2, the needle is positioned at an angle of 30° to the surface of the human body. According to the present method, any specific hand skill is not used. The disposable sterile needle (40 mm×0.25 mm; Dongbang Acupuncture, Sungnam, Korea) is determined according to Guideline based on standard acupuncture point locations, which are defined by Western Pacific Regional Office affiliated to World Health Organization [see reference 18]. While the needle is still present in place, the subject is asked to walk with help of the assistants. If the walking of the subject is improved and pain is relieved, the doctor instructs the assistants to gradually reduce the help in three steps but continuously walk with the patient. When a walking ability of the subject is improved and the pain is relieved, the help by holding is further reduced and one of the assistants stops the help. If the subject can walk without significant back pain, the other assistant also stops the help. Further, when the subject can walk without bad pain, the treatment is terminated. Such a procedure as described above generally takes about 20 minutes.

In a case where the patient feels severe pain and becomes unbearable to refuse treatment, the treatment process is immediately stopped, and an increase in pain and abnormal responses should be carefully observed and recorded.

[Determination of Results (Outcome)]

With regard to screening of patients, they fill items of the questionnaire including gender, age, body weight, blood pressure, medical history and other factors. In order to determine as to whether the subject is eligible to the present clinical study, ODI of the subject is calculated in regard to contents of the questionnaire. Back pain history, intensity of pain, functioning conditions and other factors are investigated by answering questions in the questionnaire. Further, the subject should be subjected to physical examination, X-ray and spinal MRI examinations. The back pain of the patient is evaluated at the baseline (before treatment) and 30 minutes after the treatment, respectively. The reason of the above procedure is because alleviation of pain and improvement of motion using MST are represented just after the treatment. Assessment of the results is performed by clinical researchers who are blocked from information on identification of respective treatment groups and did not participate in MST therapy.

Determination of Clinical Treatment Results

Major symptoms such as intensities of low back pain and lower limb pain and measured values of clinical treatment results such as functionality of the patient are assessed through NRS, ODI questionnaire and PGIG.

NRS is a subjective indicator for assessment but simple and used widely in the art. For NRS, the patient may select the number most representing current level of pain in the range of 0 to 10 (0: no pain, 10: the most severe pain experienced by the subject) [see references 19 and 20]. Because the severity of pain may be different between a resting period and an active period, an error in severity of pain is decreased by giving a question to the subject as follows: “Please indicate the intensity of pain felt when you start to move.”

NRS for back pain is obtained before and 30 minutes after treatment, respectively.

ODI questionnaire includes 10 items developed for evaluating a degree of disability in low back pain [see reference 21]. Each of categories has six stages wherein each stage is represented by levels 0 to 5. High score means severe disability. Approved Korean version of ODI questionnaire is adapted and filled before and 30 minutes after treatment [see reference 22].

In order to complete overall assessment for improvement of back pain and limited activity caused by back pain, PGIC is determined [see references 19 and 23]. PGIC is a method for subjective evaluation of improved condition by selecting one among seven stages as follows: stage 1, remarkably improved; stage 2, highly improved; stage 3, a little improved; stage 4, no change; stage 5, a little worse; stage 6, greatly worse; stage 7, extremely worse. These indicators were originally developed for psychiatric application, however, are now also used to assess improvement of pain in other medical applications. PGIC is determined for individual patients 30 minutes after treatment.

The above study is executed on patients with limited motion due to severe pain and, in order to assess improvement of motion before and 30 minutes after treatment, extents of ROM and SLR are examined and measured. Results of ROM measurement included level of confidence, i.e., reliability (r=0.94) and effect level, i.e., validity (r=0.97) [see reference 24], however, did not accomplish a very significant level (range of validity=0.1 to 0.6) [see reference 25]. Alternatively, SLR measurement shows high reliability (Intraclass correlation coefficient: ICC=0.95)[see reference 26]. A degree of sensitivity is 0.8 (72 to 97%) and a degree of specificity is 0.4 (11 to 66%) [see reference 27], however, these values are also not very significant levels (range of validity=0.2) [see reference 25]. Since a response to ROM and SLR measurements is not considerable, results of these measurements are used as secondary measurement results rather than primary measurement results.

ROM may be determined by measuring an angle between the spinal cord of a patient and a vertical line, in such a condition that the patient is under complete extension and flexion. When the angle cannot be measured due to pain, the angle is recorded as 0°. For measurement of SLR angle, firstly, a patient lies at full length and stretches out the legs. Then, an angle of the lower limb is determined when the patient slowly raises one of the legs. More particularly, an angle between the raised leg and the ground is measured.

The patient with low back pain may be accompanied with or without pain of the lower limbs. Symptoms may be improved by recording the pain of the lower limbs. Intensities of pain in right and left lower limbs are determined using NRS, respectively. Severity of the low limb pain is different between the resting period and the active period. Therefore, in order to minimize an error in NRS evaluation, the patient is asked to answer the following question: “Please indicate the intensity of pain felt when you start to move.” NRS for pain of the lower limbs is determined before and 30 minutes after treatment.

### Experimental Example

### Immediate Effects of Motion Style Acupuncture Treatment (MST) in Acute Low Back Pain with Severe Disability: a Multicenter, Randomized, Controlled Trial

58 aLBP participates who have serious disability defined by ODI value of more than 60% were randomly divided into two groups, i.e., MST group (n=29) and a control group treated by diclofenac injection known in the art (n=29) (see Table 1).

TABLE 1

| | Gender | Age | Period |
|---|---|---|---|
| | (male:female) | (year) | (days) |
| MST group (n = 29) | 1:0.5 | 37.9 | 29 days |
| Injection group (n = 29) | 1:0.9 | 38.7 | 27 days |

All procedures of the experiment were carried out only one time (that is, in a single period of treatment) and a result of the experiment was assessed before and 30 minutes after treatment, respectively. From original results, aBP intensity was determined using NRS.

From primary results, the intensity of the lower limb pain was determined using NRS and, if there is disability, using ODI.

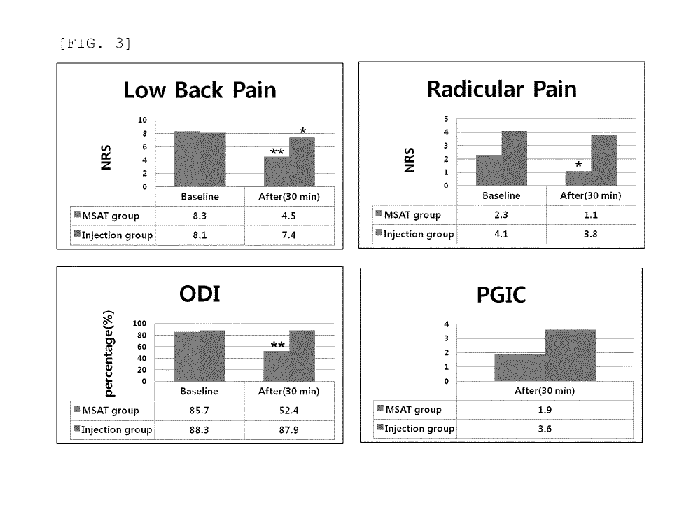

30 minutes after treatment, MST group showed that LBP, nerve root-based pain and ODI were decreased by 3.8±2.1% (p<0.001), 1.2±1.9% (p=0.001) and 33.5±15.2% (p<0.001), respectively, thus exhibiting considerable decrease in NRS. For diclofenac injection group, NRS for LBP was decreased by 0.7±1.1% (p=0.002), however, decrease rates of nerve root-based pain and ODI were only 0.3±0.7% (p=0.055) and 0.4±6.6% (p=0.866), respectively. Further, in MST group, NRS values of LBP (p<0.001), nerve root-based pain (p=0.008) and ODI (p<0.001) were considerably lower than the diclofenac injection group (see FIG. 3).

Average values of both groups stated in Table 1 above were compared by independent t-test while comparison of average values in each group was done by a pair of t-tests. Results of the above tests are shown in graphs with accompanying drawings (see FIG. 3). Referring to the drawings, it can be demonstrated that indication (*) denotes great difference (0.001≦P≦0.01) while indication (**) denotes more remarkable difference (P<0.001), compared to the baseline (before treatment).

The above results suggest that MST may positively influence instant alleviation of pain and recovery of functions in aLBP patient accompanied with severe disability. According to the above clinical studies, it may be determined as to whether MST is more superior over traditional acupuncture therapy.

### [Abbreviated Words]

### MST: Motion Style (Acupuncture) Treatment (MSAT);

### ODI: Oswestry Disability Index;

### MRI: Magnetic Resonance Imaging;

### NRS: Numerical Rating Scale;

### CRF: Case Reporting File;

### ROM: Range of Motion;

### SLR: Straight Leg Rising;

### PGIC: Patient General Image Change.

### REFERENCE

1. Rubin D I: Epidemiology and risk factors for spine pain. Neurol Clin 2007, 25(2):353-371.
2. Luo X, Pietrobon R, Sun S X, Liu G G, Hey L: Estimates and patterns of direct health care expenditures among individuals with back pain in the United States. Spine (Phila Pa. 1976) 2004, 29(1):79-86.
3. Pengel L H, Herbert R D, Maher C G, Refshauge K M: Acute low back pain: systematic review of its prognosis. BMJ 2003, 327(7410):323.
4. Waddell G: 1987 Volvo award in clinical sciences. A new clinical model for the treatment of low-back pain. Spine (Phila Pa. 1976) 1987, 12(7):632-644.
5. Woolf A D, Pfleger B: Burden of major musculoskeletal conditions. Bull World Health Organ 2003, 81(9):646-656.
6. Koes B W, van Tulder M W, Thomas S: Diagnosis and treatment of low back pain. BMJ 2006, 332(7555):1430-1434.
7. Evans G R, University of Bristol. Health Care Evaluation Unit: Low back pain: an evaluation of therapeutic interventions: University of Bristol, Health Care Evaluation Unit; 1996.
8. Bigos S J: Acute low back problems in adults: Rockville, Md. Executive Office Center, Suite 501, 2101E. Jefferson St., Rockville, 20852: U.S. Dept. of Health and Human Services, Public Health Service, Agency for Health Care Policy and Research; 1994.
9. Chou R, Qaseem A, Snow V, Casey D, Cross J T, Jr, Shekelle P, Owens D K, Clinical Efficacy Assessment Subcommittee of the American College of Physicians, American College of Physicians, American Pain Society Low Back Pain Guidelines Panel: Diagnosis and treatment of low back pain: a joint clinical practice guideline from the American College of Physicians and the American Pain Society. Ann Intern Med 2007, 147(7):478-491.
10. van Tulder M, Becker A, Bekkering T, Breen A, del Real M T, Hutchinson A, Koes B, Laerum E, Malmivaara A, COST B13 Working Group on Guidelines for the Management of Acute Low Back Pain in Primary Care: Chapter 3. European guidelines for the management of acute nonspecific low back pain in primary care. Eur Spine J 2006, 15 Suppl 2:S169-91.
11. Roelofs P D D M, Deyo R A, Koes B W, Scholten R J P M, Van Tulder M W: Non-steroidal anti-inflammatory drugs for low back pain. Cochrane Database Syst Rev 2008, (1) CD000396 (pub3).
12. Gra H, Bertram C, Schuff A, Dettmeyer R: PHARMACOLOGY OF ACUTE PAIN Intramuscular injection of diclofenac Forensic aspects of risk assessment and informed Consent. Rechtsmedizin 2006, 16(3):161-164.
13. Naesdal J, Brown K: NSAID-associated adverse effects and acid control aids to prevent them: a review of current treatment options. Drug Saf 2006, 29(2):119-132.
14. W. A. Herrmann, M. S. Geertsen: Efficacy and safety of lornoxicam compared with placebo and diclofenac in acute sciatica/lumbo-sciatica: an analysis from a randomised, double-blind, multicentre, parallel-group study. Internat J Clin Prac 2009, Volume 63(Issue 11):1613-1621.
15. Furlan A D, van Tulder M, Cherkin D, Tsukayama H, Lao L, Koes B, Berman B: Acupuncture and dry-needling for low back pain: an updated systematic review within the framework of the cochrane collaboration. Spine (Phila Pa. 1976) 2005, 30 (8):944-963.
16. Park J J, Shin J, Choi Y, Youn Y, Lee S, Kwon S R, Lee H, Kang M H, Ha I H, Shin I: Integrative package for low back pain with leg pain in Korea: a prospective cohort study. Complement Ther Med 2010, 18(2):78-86.
17. Machin D, Machin D: Sample size tables for clinical studies: 2nd ed. Oxford England; Malden, Mass., USA: Blackwell Science; 1997.
18. World Health Organization. Regional Office for the Western Pacific: WHO standard acupuncture point locations in the Western Pacific Region: Manila: World Health Organization, Western Pacific Region; 2008.
19. Farrar J T, Young J P, Jr, LaMoreaux L, Werth J L, Poole R M: Clinical importance of changes in chronic pain intensity measured on an 11-point numerical pain rating scale. Pain 2001, 94(2):149-158.
20. Turk D C, Rudy T E, Sorkin B A: Neglected topics in chronic pain treatment outcome studies: determination of success. Pain 1993, 53(1):3-16.
21. Fairbank J C, Pynsent P B: The Oswestry Disability Index. Spine (Phila Pa. 1976) 2000, 25(22):2940-52; discussion 2952.
22. Jeon C H, Kim D J, Kim S K, Kim D J, Lee H M, Park H J: Validation in the cross-cultural adaptation of the Korean version of the Oswestry Disability Index. J Korean Med Sci 2006, 21(6):1092-1097.
23. Guy W, National Institute of Mental Health Psychopharmacology Research Branch, Early Clinical Drug Evaluation Program: ECDEU assessment manual for psychopharmacology: Rev ed. Rockville, Md.: U.S. Dept. of Health, Education, and Welfare, Public Health Service, Alcohol, Drug Abuse, and Mental Health Administration, National Institute of Mental Health, Psychopharmacology Research Branch, Division of Extramural Research Programs; 1976.
24. Saur P M, Ensink F B, Frese K, Seeger D, Hildebrandt J: Lumbar range of motion: reliability and validity of the inclinometer technique in the clinical measurement of trunk flexibility. Spine (Phila Pa. 1976) 1996, 21(11):1332-1338.
25. Hart D L, Werneke M W: Re: Pengel L H M, Refshauge K M, Maher C G. Responsiveness of pain, disability, and physical impairment outcomes in patients with low back pain. Spine (Phila Pa. 1976) 2004, 29(8):879-883
26. Chow R, Adams R, Herbert R: Straight leg raise test high reliability is not a motor memory artefact. Aust J Physiother 1994, 40:107-111.
27. Rebain R, Baxter G D, McDonough S: A systematic review of the passive straight leg raising test as a diagnostic aid for low back pain (1989 to 2000). Spine (Phila Pa. 1976) 2002, 27(17):E388-395.]

What is claimed is:

1. A treatment method using a motion style treatment (MST) technique comprising: applying acupuncture to acupuncture points (‘acupoints’) at applied sites of the body of a patient; instructing the patient to move and conduct muscle motion of the above sites while applying acupuncture thereon, which in turn maximizes circulation of bio-energy on the applied sites; and activating stimulation of muscles, ligaments and/or nerves by acupuncture needles to maximize effects of acupuncture stimulation, wherein acute low back pain having serious disability accompanied with or without pain of the lower limbs is representative of clinical applications of the above treatment.

2. The method according to claim 1, wherein:
assistants take off shoes and socks and putting galoshes on a patient, then, stand up at both sides of a subject, that is, the patient;
the assistants help the subject to stand up with their arms around the shoulder of the subject, then, tug at the hands and waist of the subject, respectively, like as they raise their hands, to conduct traction of the body of the subject, while putting the arms of the subject on the shoulders of the assistants; wherein the assistants closely contact the patient as much as possible at their flanks to sufficiently conduct traction of the body of the patient;
at this position, an oriental medical doctor applies acupuncture by inserting disposable needles into punbu acupoint GV16, both henggan acupoints LR2 and both gokji acupoints LI11 at each depth of 10 to 15 mm;
while the needle is still present in place, the subject is asked to walk with help of the assistants;
if the walking of the subject is improved and pain is relieved, the doctor instructs the assistants to gradually reduce the help in three steps but continuously walk with the patient;
when a walking ability of the subject is improved and the pain is relieved, the help by holding is further reduced and one of the assistants stops the help;
if the subject can walk without significant back pain, the other assistant also stops the help; and,
when the subject can walk without bad pain, the treatment is terminated.

3. The method according to claim 2, wherein the above procedures take a time period of less than 1 hour.

4. The method according to claim 1, wherein the above acupoints are selected according to traditional theory of oriental medicine and the past clinical medical experiences.

5. The method according to claim 1, wherein, when applying acupuncture to both lateral sides of GV16 and LI11, the needles are aligned on spots perpendicular to the surface of the human body and, for LR2, the needle is positioned at an angle of 30° to the surface of the human body.

6. The method according to claim 1, wherein a size of a disposable sterile needle used herein is 40 mm×0.25 mm; and determined according to Guideline based on standard acupuncture point locations, which are defined by Western Pacific Regional Office affiliated to World Health Organization.

7. The method according to claim 1, wherein, before conducting MST, Chuna therapy is conducted to relax muscles or ligaments in corresponding diseased parts as a pre-treatment process.
